(19) United States
(12) Patent Application Publication
(10) Pub. No.: US 2003/0021918 A1
(43) Pub. Date: Jan. 30, 2003

(54) Metalized shrink label and related method of manufacture

(76) Inventor: Barron G. McKillip, Laverne, CA (US)

Correspondence Address: WARNER NORCROSS & JUDD LLP, 900 FIFTH THIRD CENTER, 111 LYON STREET, N.W., GRAND RAPIDS, MI, 49503-2487, US

(21) Appl. No.: 09/916,371

(22) Filed: Jul. 27, 2001

(51) Int. Cl. B32B 1/02; B05D 1/36

(52) U.S. Cl. 428/34.1; 427/404; 427/407.1

(57) ABSTRACT

A metalized shrink film for contoured containers and other articles and a process for manufacturing the same. A preferred metalized shrink film includes a heat-shrinkable film layer, a varnish disposed over the film on at least one side, and a metalized layer disposed over the varnish. The metalized layer is preferably viewable through the heat-shrinkable film layer. Preferably, the varnish is a clear and ultraviolet curable, and the heat-shrinkable film includes images or graphics. A preferred method of manufacturing the metalized shrink film includes: providing a heat-shrinkable film material; applying varnish over the film; and applying a metal material over the varnish and any regions of the film not covered by the varnish. Preferably, the heat shrink film is incorporated into a heat-shrinkable label or sleeve used on contoured containers, such as bottles. When the label or sleeve is shrunk over contours of the container, the metalized regions viewable through the film and the images or graphics on the film do not discolor or become cloudy near the contours.

### BACKGROUND

The present invention relates to heat-shrink labels and sleeves for containers and other articles.

A variety of labels are available to provide information or advertisements on products, typically with graphics or images printed on the viewable portion of the labels. One popular label construction is a shrink label. Shrink labels are usually applied around contoured cylindrical containers, such as bottles, cans and the like. These labels get their name from the way they are applied to the containers—a heat-shrinkable material is formed into a tube; the tube is placed over the container; the tube or container is heated; and the material shrinks around and secures the label to the container in response to the heat.

Typically, a shrink label is constructed from a material that shrinks in response to heat—such as a heat-shrinkable film—so that the label readily conforms to contours of an article to which it is applied. Many attempts have been made to enhance the graphics, images, or overall aesthetic appeal of shrink labels, however, these attempts usually are limited by distortion of the shrink label around contours of articles during shrinkage.

In one attempt to enhance the graphics of a shrink label, silver ink is printed directly on the heat shrink film to add a metallic appearance to the label. Although this application enhances the appearance of a shrink label in its un-shrunken state, after the label is shrunken onto an article, the silver ink becomes hazy, cloudy and generally discolored near the contours. Accordingly, the overall visual appeal of the shrink label is decreased rather than enhanced as intended.

### SUMMARY OF THE INVENTION

The aforementioned problems are overcome in the present invention wherein a shrink film includes a metallic or reflective layer. More particularly, the metalized shrink film of the present invention includes a shrink film, a layer of varnish or plastic extrusion disposed over a surface of the shrink film, and a metallic or reflective layer—the “metalized layer”—disposed over the varnish or plastic extrusion layer. This metalized shrink film may be incorporated into shrink sleeves or labels. Preferably, the varnish is clear, and portions of the metalized layer are viewable through the shrink film to enhance images or graphics or the overall appearance of the article to which the heat shrink label is applied.

With the construction of the present invention, it is possible to enhance images and graphics on shrink labels with highly reflective or metallic-like effects because the layer of varnish or plastic extrusion prevents or at least minimizes metalized layers from discoloring and becoming cloudy or hazy when the label is shrunk over contours of articles.

A preferred process of manufacturing the metalized shrink label includes (a) applying varnish or a plastic extrusion over an un-shrunken heat shrinkable film, and (b) applying a metal-like material over the varnish or plastic extrusion, and over any regions of the heat-shrinkable film that are not covered by the varnish or plastic extrusion.

These and other objects, advantages and features of the invention will be more readily understood and appreciated by reference to the detailed description of the preferred embodiments and the drawings.

### BRIEF DESCRIPTION OF THE DRAWINGS

FIG. 1 is a perspective, cut-away view of a contoured article including a metalized heat shrink label of the present invention; and

FIG. 2 is an enlarged view taken from view 2 in FIG. 1.

### DETAILED DESCRIPTION OF THE PREFERRED EMBODIMENTS

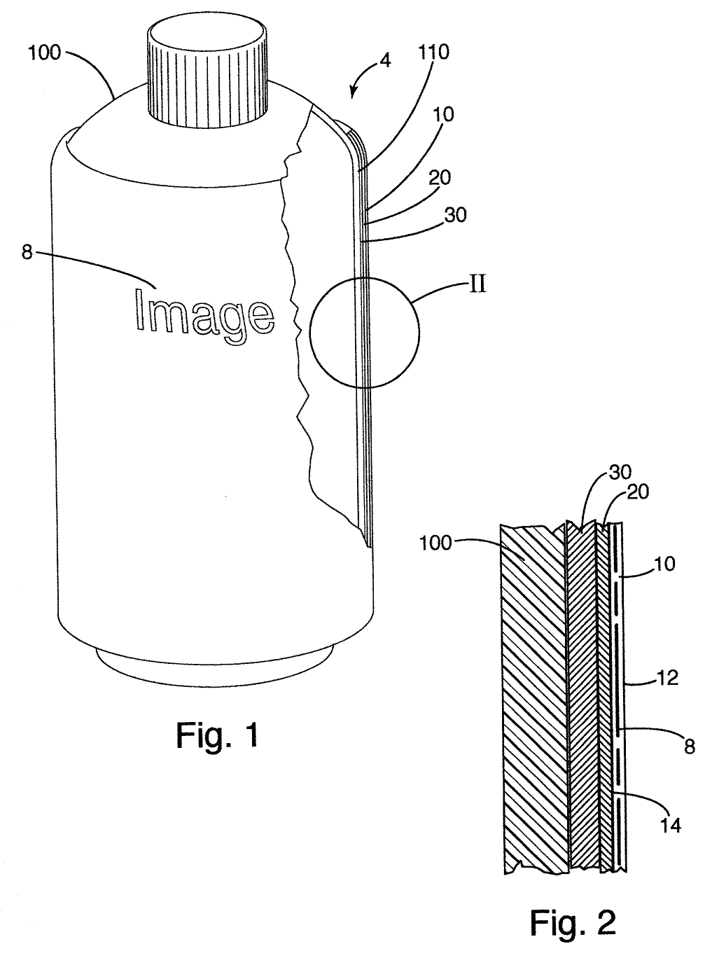

The preferred metalized shrink film of the present invention will be described in connection with a metalized shrink label 4 applied to bottle 100 as shown in FIGS. 1 and 2. The metalized shrink label generally includes shrinkable film layer 10, varnish layer 20 and metalized layer 30.

As shown in FIG. 1, the metalized shrink label (exaggerated in thickness) is in the form of a shrink sleeve, conforming to the contours 110 of the bottle 100. It will be appreciated that the construction of the shrink label used in any application where a shrink label or sleeve is desired. Accordingly, when used herein, shrink label refers to any shrink label construction, including a shrink sleeve.

With further reference to the blown-up view of the shrink label 4 in FIG. 2, the shrinkable film layer 10 is constructed from any material capable of shrinking when subjected to a physical condition. Preferably, the shrinkable film layer shrinks in response to the application of heat thereto. The film layer 10 may be of any commercially available heat shrinkable material, for example, polypropylene, polyethylene, polyvinyl chloride, polyethylene terephthalate and polystyrene foam. Preferably, the film includes graphics or images 8, in text or pictorial form, to enhance the appearance of the label or provide information to consumers. These graphics may be printed on or in or otherwise associated with the film in any commercially acceptable manner.

Preferably, the film layer 10 provides regions through which the metalized layer may be viewed when a consumer views the label. Optionally, the graphics and or images are configured to create special visual effects when combined with the appearance of the metalized layer 30.

Cover layer 20 is disposed on surface 14 of the film layer 10. The function of this cover layer 20 is to prevent the metalized layer 30 from discoloring when the shrink label conforms to contours of an article to which it is applied. Preferably, this cover layer is varnish, printed or otherwise applied over the film layer 10. Optionally, the varnish may be replaced with any commercially available plastic extrusion material, including but not limited to, low density polyethylene, ethylene vinyl acetate, an extrudable plastic identified by the trademark SYRLAN and any commercially available extrudable copolymer. In the preferred embodiment, the varnish is transparent, so that the metalized layer may be viewable through it, as well as portions of the film layer 10. More preferably, the varnish is curable with ultra-violet light so that the film is not affected or deformed on application of the varnish to the film layer 10.

Optionally, the varnish or plastic extrusion may be selectively disposed in regions of the shrink label that correspond to contours of an article to which the label will be applied. In this manner, the amount of material used to prevent or minimize discoloring of the metalized layer around contours may be minimized. As used herein, discoloring or discoloration refers to the alteration of the appearance of the metalized layer or the film layer covering the metalized layer and includes, but is not limited to, situations where the metalized layer appears cloudy, hazy, whitened, or generally does not appear uniformly colored and situations where the appearance of the graphics or images associated with the film layer is altered due to the clouding, hazing, whitening or non-uniform coloring of the metalized layer.

As best shown in FIG. 2, metalized layer 30 is disposed over the cover layer 20 and/or film layer 10 where not covered by the cover layer. The metalized layer is generally a layer of semi-metallic, metallic, and/or reflective material. Preferably, portions of the metalized layer 30 are viewable through the film layer 10 and enhance the graphics or images of the label. In a preferred embodiment, the metalized layer 30 is silver ink printed over the cover layer 20 and/or portions of the rear surface 14 of the film layer 10. The metalized layer may be of a variety of other constructions. Optionally, the metalized layer may be of any colored or reflective appearance similar to a metal or mirrored surface.

In another embodiment, the metalized layer 30 is a layer of silver or chrome paint. The layer may also be a chrome-colored or other metallic or reflective ink layer printed over the cover layer 20 and/or portions of the rear surface 14 of the film layer 10. In yet another embodiment, the metalized layer is a commercially available metal foil, laminated over the cover layer 20 and/or portions of the rear surface 14 of the film layer 10.

The metalized layer may also be a commercially available hot stamp foil, stamped over the cover layer 20 and/or portions of the rear surface 14 of the film layer 10. Alternatively, the metalized layer may be a construction formed by electroplating an appropriate dry reflective powder, for example an aluminum or silver based powder, over the cover layer 20 and/or portions of the rear surface 14 of the film layer 10. In addition, the metalized layer 30 may be any layer of commercially available material capable of being vacuum metalized to a varnish, plastic extrusion or heat shrinkable film. As will be appreciated, the metalized layer 30 may be constructed of any commercially available material that provides a metal-colored or reflective appearance.

Optionally, the metalized layer 30, on the side opposite the cover layer 20, may be covered with a protective layer of material (not shown), such as another layer of varnish, laminate, paint, or ink, to protect it from being damaged by abrasion.

Method of Manufacture

A preferred process of manufacturing the metalized shrink film of the present invention will now be described. The preferred process generally includes (a) applying a cover layer over a shrinkable film when the film is in its un-shrunken state and (b) applying a metal material onto the film, over the cover layer.

Preferably, a continuous length of shrinkable film is provided. It passes continuously through a printing station where a varnish is printed over the rear surface of the film. The varnish is preferably allowed to cure or actively cured. In a preferred embodiment, the varnish is ultraviolet curable, thus the varnish is actively cured with ultra violet light. Thereafter, the film is passed through a metalizing station where a metalized layer, including any of the embodiments discussed above, is disposed over the varnish. If the varnish does not completely cover all regions of the film, the metalized layer may be deposited on the film as well. Optionally, the metalized layer may be covered with a protective layer to prevent it from becoming damaged or otherwise altered on the surface of the metalized layer opposite the varnish layer.

After the metalized shrink film is manufactured, it may be further processed into shrink sleeves or other labels and applied to articles in known manners. For example, the shrink film may be rolled into tubes or jackets and heat shrunk onto containers or other articles. Notably, due to the construction of the metalized shrink film, the metalized layer of the resultant applied labels and the graphics and images of the film layer do not discolor around contours of he article to which the label is applied.

The above descriptions are those of the preferred embodiments of the invention. Various alterations and changes can be made without departing from the spirit and broader aspects of the invention as defined in the appended claims, which are to be interpreted in accordance with the principles of patent law including the doctrine of equivalents. Any references to claim elements in the singular, for example, using the articles “a,” “an,” “the,” or “said,” is not to be construed as limiting the element to the singular.

The embodiments of the invention in which an exclusive property or privilege is claimed are defined as follows:

1. A heat shrink label for a contoured article comprising:
a film layer including a first side and a second side;
a substrate, chosen from a varnish and a plastic extrusion, disposed over said first side in at least one area; and
a metalized layer disposed over said at least one area and at least partially viewable through said film layer.

2. The heat shrink label of claim 1 wherein said metalized layer is reflective.

3. The heat shrink label of claim 2 wherein said metalized layer is at least one chosen from a silver ink, a chrome ink, a silver paint and a chrome paint.

4. The heat shrink label of claim 3 wherein said substrate is an ultra violet light curable, transparent varnish.

5. The heat shrink label of claim 1 wherein said substrate is a transparent plastic extrusion layer.

6. The heat shrink label of claim 1 wherein said at least one area corresponds to at least one contour of the contoured article to which the heat shrink label is applied.

7. A shrink film comprising:
a first shrinkable film layer including a first side and a second side;
a second layer disposed on said second side; and
a metal substrate disposed over said second layer, said metal substrate viewable through said first layer.

8. The shrink film of claim 7 wherein said second layer is a varnish or plastic extrusion.

9. The shrink film of claim 8 wherein said varnish is ultraviolet curable.

10. The shrink film of claim 7 wherein the second layer prevents the metal layer from discoloring when the shrink film is shrunk around a contoured article.

11. The shrink film of claim 10 wherein the first layer is a heat-shrinkable film.

12. The shrink film of claim 1 1 wherein the film includes images or graphics.

13. The shrink film of claim 12 wherein the second layer prevents the images or graphics from discoloring when the shrink film is shrunk around a contoured article

14. The shrink film of claim 7 wherein the metal substrate is chosen from silver ink, chrome ink, silver paint and chrome paint.

15. The shrink film of claim 7 wherein the metal substrate is electroplated over said second side.

16. The shrink film of claim 7 wherein said metal substrate is hot foil stamped over said second layer.

17. The shrink film of claim 7 wherein said metal substrate is vacuum metalized over said second layer.

18. A labeled container comprising:
a surface including a contour;
a heat-shrinkable label, shrunken over said contour, said label including:
a film,
a metal layer disposed over said film, and
a cover layer disposed between said film and the metal layer, said metal layer viewable through said film in at least one region, said cover layer preventing discoloration of said metal layer adjacent said contour.

19. A method for manufacturing a shrink film comprising:
applying at least one of a varnish and a plastic layer over a surface of a shrink film; and
applying a metal material over the at least one of a varnish and a plastic layer.

20. The method of claim 19 wherein the at least one of the varnish and plastic layer are transparent.

21. The method of claim 19 wherein the shrink film is constructed of a plastic chosen from polypropylene, polyethylene, polyvinyl chloride, polyethylene terephthalate and polystyrene foam.

22. The method of claim 19 comprising curing the varnish with ultra violet light.

23. The method of claim 19 wherein the metal material is a reflective ink or paint.

24. The method of claim 19 wherein the metal material is viewable through the shrink film.

25. The method of claim 19 wherein the film includes graphics or images.

26. The method of claim 19 wherein the metal material is applied over the varnish by a technique chosen from vacuum metalizing, electroplating, painting, printing, film lamination and hot stamping.

27. A method for metalizing a heat shrinkable label which is resistant to discoloration or clouding when the film is heat-shrunk over contoured articles, comprising:
providing a length of un-shrunken, heat-shrinkable film;
printing at least one layer of varnish over the heat shrinkable film; and
metalizing the heat shrinkable film in at least one region of the film printed with the layer of varnish.

28. The method of claim 27 wherein the varnish is ultra violet light curable.

29. The method of claim 27 wherein the heat shrinkable film is at least one of polypropylene, polyethylene, polyvinyl chloride, polyethylene terephthalate and polystyrene foam.

30. The method of claim 27 wherein the heat shrinkable film is metalized by a technique chosen from vacuum metalizing, electroplating, painting, printing, film lamination and hot stamping.

31. The method of claim 27 comprising applying a protective layer over the heat shrinkable film after said metalizing.

32. The method of claim 27 comprising curing the varnish with ultra violet light.

33. The method of claim 27 wherein the plastic layer is a plastic extrudable copolymer.

34. The method of claim 33 wherein the copolymer is chosen from low density polyethylene and ethylene vinyl acetate.
